(19) United States
(12) Patent Application Publication
(10) Pub. No.: US 2006/0080775 A1
(43) Pub. Date: Apr. 20, 2006

(54) Lifting sling

(76) Inventors: Nathan McWattie, Cheltenham (GB); Phillip Hollingworth, Hong Kong (HK); John Gardener, Banbury (GB)

Correspondence Address: MACMILLAN SOBANSKI & TODD, LLC;ONE MARITIME PLAZA FOURTH FLOOR, 720 WATER STREET, TOLEDO, OH, 43604-1619, US

(21) Appl. No.: 11/251,285

(22) Filed: Oct. 14, 2005

(30) Foreign Application Priority Data
Oct. 14, 2004 (GB) 0422758.3

(51) Int. Cl. A61G 7/14

(52) U.S. Cl. 5/89.1

(57) ABSTRACT

A lifting sling for supporting a person from a hoist has at least one reinforcing element fitted to the surface of the sling by detachable fastening means.

### CROSS REFERENCE TO RELATED APPLICATIONS

This application claims the benefit of U.K. Patent Application No. 0422758.3, filed on Oct. 14, 2004.

### BACKGROUND OF INVENTION

This invention relates to a lifting sling for supporting a person from a hoist. Lifting slings are well known for such use, being detachably suspended from the hoist and being arranged to extend beneath at least the main part of the torso of a person such as an invalid or patient.

Known lifting slings are made from a flexible sheet material able to bear the weight of a person, typically a woven textile material of synthetic fiber. One or more pieces of the sheet material is or are suitably seamed and joined to give the sling a three-dimensional shape, which generally conforms to a typical person's torso shape. In a region in the vicinity of the shoulders of a person supported in the sling, the sling is provided with two laterally spaced attachment devices for suspending the sling from attachment formations on a lifting cradle connected to the hoist. At the opposite end of the sling (the length of the sling being taken herein to be the direction of the height of a person being supported by the sling, and terms such as laterally, longitudinally, and the like being construed accordingly), the sling is bifurcated, with two parts which pass beneath the respective thighs and upper legs of the person, and upwardly between the person's legs. End regions of these parts of the sling are provided with respective further attachment devices which are connected to respective second attachment formations on the lifting cradle.

The present invention relates to the support of the head of a person who is supported by the sling in the manner described above. The first attachment devices of the sling suspend the sling in the vicinity of the persons shoulders, and the head of the person does of course extend therebeyond. The sling may have a head-support portion extending beyond where the first attachment devices are provided, but since the sling is made from a flexible material, such as a textile fabric, it does not in itself provide much support for the person's head. For the comfort of a person, it is important that some head support be provided.

To provide a sling with a further attachment or suspension device or devices for a head-supporting region of the sling would greatly increase the complexity of both the sling and the cradle by which it is suspended from a hoist. It has been proposed that a head-supporting region of a sling can be reinforced by providing stiffening elements in pockets provided in the sling, but such provision significantly increases the complexity of the sling's construction and hence is expensive; also it is not particularly versatile in the sense that it reinforces the sling in a pre-determined aspect only and is not adaptable should a different mode of reinforcement be desired.

What is needed is a lifting sling which is improved in respect of its provisions of support for the head of a person supported by the sling.

### SUMMARY OF INVENTION

The present invention relates to a lifting sling that meets the foregoing needs. The lifting sling has at least one reinforcing element fitted to the surface of the sling by one or more detachable fasteners. Alternatively, the reinforcing element may be fitted to the sling in a non-detachable manner, such as by stitching the reinforcing element to the surface of the sling.

The invention may also relates to a lifting sling that is adapted to be connected to a hoist by connecting elements which in normal use lie in the vicinity of the shoulders of a person supported by the sling. The sling comprises a head-support portion which extends beyond the connecting elements, wherein there is provided a reinforcing element fitted to the surface of the sling and extending from the region of the connecting elements into the area of the head support portion of the sling. The reinforcing element may be fitted to the sling in a detachable or non-detachable manner.

Various objects and advantages of this invention will become apparent to those skilled in the art from the following detailed description of the preferred embodiment, when read in light of the accompanying drawings.

### BRIEF DESCRIPTION OF DRAWINGS

The invention will now be described by way of example with reference to the accompanying drawings, of which

FIG. 1 illustrates a lifting sling of a type to which the invention relates, in use.

FIG. 2 is a perspective view of the lifting sling with its reinforcing element removed.

FIG. 3 is a view as FIG. 2 but with the reinforcing element in situ.

FIG. 4 is a view of the reinforcing element.

### DETAILED DESCRIPTION OF THE INVENTION

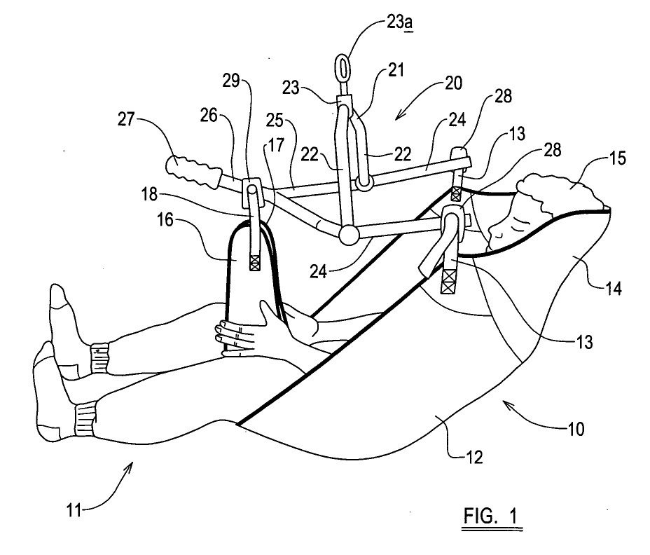

Referring now to FIG. 1 of the drawings, there is shown a lifting sling in accordance with the invention, in use. The sling, indicated generally at 10, is made of a flexible sheet material, such as a woven fabric of sufficient strength to carry the loads to which it is to be subjected in use. Alternatively, the sling or part thereof may be of a netting material, or may comprise two or more layers of material with a padding material therebetween. The sling is illustrated with a person 11 (e.g., a patient) supported therein and the sling comprises a part 12 which supports the torso of the person 11. The part 12 of the sling is provided, in the vicinity of the shoulders of the person 11, with laterally spaced connecting elements 13 which are in the form of straps or tapes made of a suitably strong flexible material (e.g., a webbing material made of an artificial fiber). The connecting elements 13 are sewn to the material of which the sling 10 is made. Beyond the regions where the connecting elements 13 are attached to the sling, the sling has a head support portion 14 for supporting the head 15 of the person 11.

The main part 12 of the sling extends to a region generally beneath the lower torso/upper legs of the person 11, and then is bifurcated to afford two elongate leg-support portions 16, 17 which are passed beneath the respective upper legs/thighs of the person 11 and upwardly between the legs to the illustrated position. Each of the leg-support portions 16, 17 is provided at its end with a flexible connecting element like the connecting elements 13: such a connecting element is indicated at 18 at the end of the leg support portion 16.

The sling is made from one or more pieces of the flexible sheet material, cut and joined together (e.g., by stitching) to give the sling a three dimensional shape which comfortably supports a person held by the sling.

The sling is arranged to be connected to a hoist such as an invalid hoist, and in FIG. 1 the sling is shown connected to a supporting cradle, indicated generally at 20.

The cradle 20 comprises a member 21 which is generally of inverted U-shape, having a pair of limbs 22 which extend outwardly and downwardly from a member 23 provided with a formation 23a enabling it to be connected to the jib of a hoist. Such connection may provide for pivoting of the member 21 relative to the jib of the hoist, about a generally vertical axis. The bottom ends of the limbs 22 are connected, for pivoting about a generally horizontal axis, to spaced limbs 24 of a somewhat Y-shaped carrying member 25. The spaced limbs 24 of the Y-shaped member 25 join into a single limb 26 which ends in a handle 27. The connecting elements 13 and 18 are each provided with an attachment device for engagement with attachment formations on the carrying member 25, and the attachment devices on the connecting elements 13 are indicated at 28 and that on the visible connecting element 18 is indicated at 29, all the attachment devices being the same as one another. Attachment formations on the conveying member 25, with which the attachment devices are engageable, are provided adjacent the free ends of the spaced limbs 24, facing outwardly from one another, and on opposite sides of the limb 26.

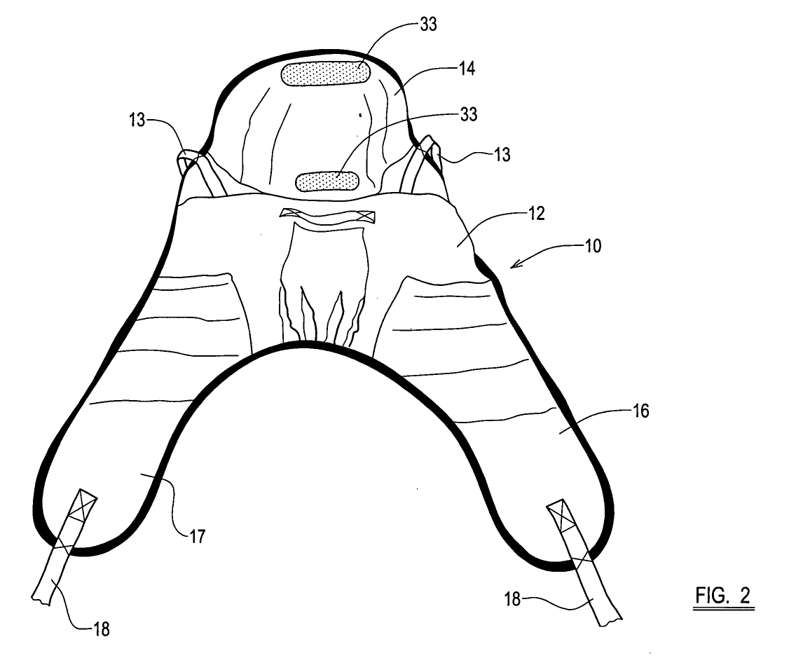

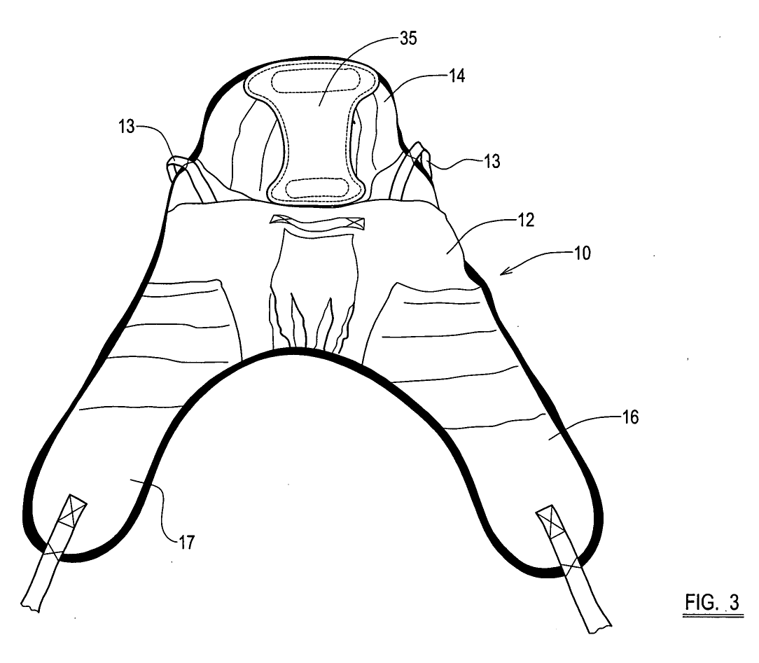

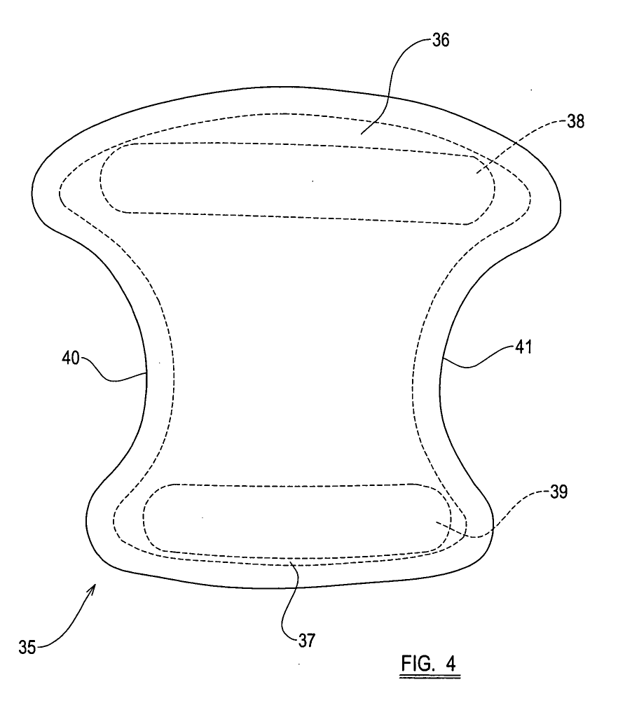

Referring now to FIGS. 2 and 3 of the drawings, there is show the sling 10 and the principal parts thereof as described above. In FIG. 2, it can be seen that between the positions where the flexible connecting elements 13 are secured to the material of the sling (which elements, with the attachment devices 28 thereon, which are not shown in FIGS. 2 and 3 constitute attachment means for the sling), the sling is provided with an element 32 which is one part, preferably the “loop” part, of a hook and loop fastening system such as that sold under the registered trademark Velcro. A further element 33 of such material is fitted to the surface of the sling adjacent the top of the head-support portion 14 thereof. These fastening elements provide for the detachable fitment to the sling of a reinforcing element 35 which is shown in FIG. 4 and shown in situ in FIG. 3. The invention thus enables a lifting sling to be adapted for particular purposes by the simple replacement of the reinforcing element by a different type thereof. The reinforcing element is easily able to be removed for washing when required.

The reinforcing element 35 comprises a top portion 36 and a bottom portion 37 which are provided, on their sides which face the surface of the head support portion 14 of the sling, with elements 38 and 39 of the hook and loop fastening material, complementary to the elements 33, 32, thereof respectively.

The top portion 36 of the reinforcing element 35 is wider than the bottom portion 37 thereof, and the elements 33, 32, 38, 39 of the fastening material are correspondingly dimensioned. Between the top and bottom portions, the sides of the reinforcing element 35 are waisted as indicated at 40, 41. In use, the bottom portion 37 of the reinforcing element is held between the sling and the shoulders of the person supported thereby and reinforces and stiffens the sling in this region, while the top portion 36 of the reinforcing element curves behind the upper part of the head of the person supported by the sling.

The reinforcing element 35 is constructed of sheet material so that it is flexible but substantially stiffer than the material on which the sling is made so as to be able to adequately support the head of the person being supported by the sling. It may comprise an envelope or casing of textile material as that of the sling, containing a stiffening element which may be of polypropylene or other sheet plastics material, of sufficient thickness to render it stiff enough to reinforce the head-support portion of the sling but nevertheless sufficiently flexible to conform to the contour of a persons head, so that it is comfortable. It may be padded as required for the comfort of a person being supported by the sling, and provided with surface parts of any appropriate material to suit different conditions of a person being supported.

Reinforcing elements may be provided in a number of different sizes and materials, to render them more suitable for particular purposes. For example reinforcing elements of different thicknesses or comfort levels may be provided. Reinforcing elements of different materials may be provided if they are likely to contact areas of the persons skin presenting different problems, e.g. if the person has burns or areas of sore skin.

Reinforcing elements may be useful in the provision of reinforcement or additional support in other parts of a sling, for parts other than the head of a person being supported by the sling.

It should be appreciated that other suitable detachable fastening devices could be used, such as clips or press studs, as long as they do not present rigid protuberances or the like which could be detrimental to the comfort of a person being supported by the sling. Alternatively, the reinforcing element 35 may be attached in a non-detachable manner, such as by stitching the reinforcing element 35 to the sling.

The principle and mode of operation of this invention have been explained and illustrated in its preferred embodiment. However, it must be understood that this invention may be practiced otherwise than as specifically explained and illustrated without departing from its spirit or scope.

What is claimed is:

1. A lifting sling for supporting a person from a hoist, having at least one reinforcing element fitted to the surface of the sling by one or more detachable fastening elements.

2. A lifting sling according to claim 1 wherein the reinforcing element is provided in a head-support portion of the sling.

3. A lifting sling according to claim 1 wherein the one or more fastening elements comprise respective parts of one or more hook and loop fastening devices provided on the sling and on the reinforcing element.

4. A lifting sling for supporting a person from a hoist, the sling being adapted to be connected to the hoist by means including connecting elements which in normal use lies in the vicinity of the shoulders of a person supported by the sling, the sling comprising a head-support portion which extends beyond the connecting elements, wherein there is provided a reinforcing element detachably fitted to the surface of the sling and extending from the region of the connecting elements into the area of the head support portion of the sling.

5. A lifting sling according to claim 1 wherein the reinforcing element comprises a piece of sheet material which is flexible but stiffer than the material of which the sling is made.

6. A lifting sling according to claim 5 wherein the reinforcing element comprises a casing made of a material at least similar to that of which the sling is made, containing a stiffening element.

7. A lifting claim according to claim 6 wherein the reinforcing element includes a padding material.

8. A lifting sling according to claim 5 wherein the reinforcing element is fitted to the sling by complementary fastening elements provided on the sling and the reinforcing element.

9. A lifting sling according to claim 8 wherein the complementary fastening elements comprise respective elements of hook and loop fastening material.

10. A lifting sling according to claim 1 whereas wherein the reinforcing element comprises a portion which extends transversely of the sling at a position which lies behind the upper part of the head of a person occupied by the sling, and a portion which lies behind the shoulders of the person.
